(19) United States
(12) Patent Application Publication
(10) Pub. No.: US 2002/0111141 A1
(43) Pub. Date: Aug. 15, 2002

(54) Communication method and system using elastic wave

(75) Inventor: Hiroshi Furukawa, Tokyo (JP)

Correspondence Address: SUGHRUE MION, PLLC, 2100 Pennsylvania Avenue, NW, Washington, DC, 20037-3213, US

(73) Assignee: NEC CORPORATION

(21) Appl. No.: 10/041,742

(22) Filed: Jan. 10, 2002

(30) Foreign Application Priority Data
Jan. 12, 2001 (JP) 005468/2001

(51) Int. Cl. H04B 7/00; H04Q 7/20

(52) U.S. Cl. 455/41; 455/517

(57) ABSTRACT

In a communication system for performing short-range radio communication between a plurality of communication nodes, each of the communication nodes includes a transmission/reception unit and first and second circuits. The transmission/reception unit transmits/receives an elastic wave. The first circuit drives the transmission/reception unit on the basis of transmission data. The second circuit demodulates reception data from an output from the transmission/reception unit. A communication method is also disclosed.

### BACKGROUND OF THE INVENTION

The present invention relates to a communication system using elastic waves and, more particularly, to a communication method and system which can support mobile units.

The number of terminals in communication systems which support mobile units, e.g., portable telephones and radio LAN (Local Area Network) units has already exceeded the number of stationary telephones. That is, these systems have already formed an indispensable social infrastructure. In such mobile communication, electromagnetic waves, e.g., radio waves and infrared light, are used as communication means.

FIG. 13 schematically shows how conventional mobile communication is performed. A communication node 702 communicates with a communication node 701. A communication line 703 is used for communication using electromagnetic waves. Of the systems using electromagnetic waves, a large number of mobile communication systems using the ISM (Industrial, Scientific and Medical) band, in particular, have been developed. The ISM band requires no radio station license and allows a reduction in the manufacturing cost of devices. For these reasons, there is a tremendous growth in demand for the ISM band. Of the mobile communication systems using the ISM band, a radio system that forms a so-called personal area network used for home and office radio LANs and short-range communication has attracted a great deal of attention.

For example, the radio system that forms a personal area network is used as follows. A personal computer having a radio communication interface is put in a bag. The radio interface in the bag is used for communication between the personal computer and the handset carried by a user. In this case, the user can perform operation by using the handy type compact handset without taking the large personal computer from the bag.

An abrupt increase in demand for mobile communication has led to a stringent demand for electromagnetic wave frequencies. Since the frequency band below the microwave band is occupied by various communications and broadcasts, almost no frequency is available for new demands. On the other hand, it is pointed out that electromagnetic waves have adverse effects on the human body. When a user uses a portable telephone integrally having an antenna, microphone, and speaker, it is inevitable that the antenna portion comes close to the user's head. The head therefore receives strong electromagnetic waves. It has also been reported that portable telephones affect heart pacemakers.

As described above, it has been pointed out that communication systems using electromagnetic waves have adverse effects on the human body. This tends to form the social consensus that the use of communication devices using electromagnetic waves should be avoided in places where many people gather. For example, such cases correspond to cases where users use buses and trains. However, urgent communication may be required in any place at any time. Therefore, there is no way to completely suppress people's desire to perform mobile communication in buses and trains.

In order to suppress interference between communication devices using electromagnetic waves as radio transmission means, it is required to minimize radiation of electromagnetic waves into an unnecessary space. Various means have been studied to realize this, including a means using a wall made of a special material for preventing leakage of electromagnetic waves such as an electromagnetic field, a means for coupling a receiver with a waveguide, coaxial cable, or the like, and a means for limiting radiation directions by adjusting the directivity of an antenna. However, each of these means is not an article for daily use, and requires a dedicated unit with limited applications.

The above radio system for a personal area network takes the trouble to radiate electromagnetic waves for short-range communication, and hence cannot be said to effectively use the limited electromagnetic wave frequency resources. In addition, if a plurality of radio communication systems using the ISM band, interference between the systems will raise a serious problem that cannot be neglected.

On the other hand, as a communication system using elastic waves, the communication system disclosed in Japanese Patent Laid-Open No. 63-269635 is known. According to the communication system disclosed in this reference, a diver uses elastic waves as means for communicating with a mothership. Elastic waves can propagate far in the water, and hence can be effectively used. However, elastic waves do not easily propagate in the air. This has retarded the commercialization of communication systems using elastic waves.

### SUMMARY OF THE INVENTION

It is an object of the present invention to provide a communication method and system using elastic waves which can perform short-range communication without using any electromagnetic wave.

In order to achieve the above object, according to the present invention, there is provided a communication system for performing short-range radio communication between a plurality of communication nodes, wherein each of the communication nodes comprises a transmission/reception unit which transmits/receives an elastic wave, a first circuit which drives the transmission/reception unit on the basis of transmission data, and a second circuit which demodulates reception data from an output from the transmission/reception unit.

### BRIEF DESCRIPTION OF THE DRAWINGS

FIG. 1 is a block diagram of a communication system according to an embodiment of the present invention;

FIG. 2 is a plan view of an ultrasonic apparatus used in the communication system in FIG. 1;

FIG. 3 is a flow chart for explaining reception processing in the communication system in FIG. 1;

FIG. 4 is a flow chart for explaining transmission processing in the communication system in FIG. 1;

FIG. 5 is a block diagram showing an example of the communication system using air as a transmission medium;

FIG. 6 is a block diagram showing another example of the communication system using air as a transmission medium;

FIG. 7 is a block diagram showing an example of the communication system using a desk, which is a solid object, as a transmission medium;

FIG. 8 is a block diagram showing another example of the communication system using a desk, which is a solid object, as a transmission medium;

FIG. 9 is a block diagram showing still another example of the communication system using a desk, which is a solid object, as a transmission medium;

FIG. 10 is a block diagram showing a case where the present invention is applied to a cellular mobile communication system;

FIG. 11 is a block diagram showing an example of the transmission/reception circuit provided at a communication node;

FIG. 12 is a block diagram showing another example of the transmission/reception circuit provided at a communication node; and

FIG. 13 is a view schematically showing how conventional mobile communication is performed.

### DESCRIPTION OF THE PREFERRED EMBODIMENTS

The present invention will be described in detail below with reference to the accompanying drawings.

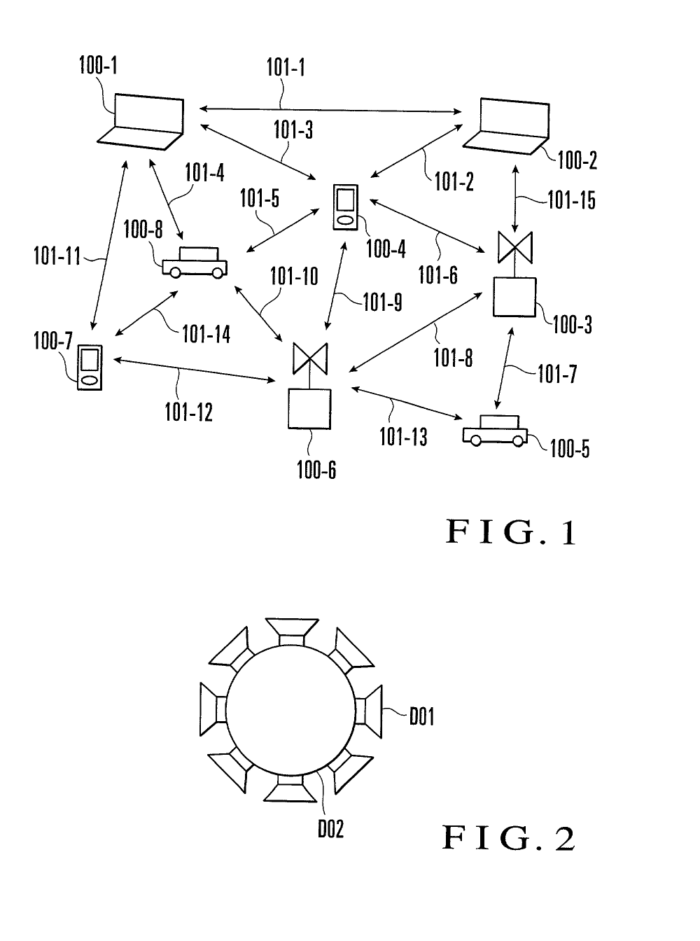

FIG. 1 shows a communication system according to an embodiment of the present invention. Referring to FIG. 1, a plurality of communication nodes 100-1 to 100-8 are connected to each other through communication lines 101-1 to 101-15. The communication nodes 100-1 to 100-8 are either stationary or movable. Examples of the communication nodes 100-1 to 100-8 are peripheral devices such as keyboards, printers, and displays as well as information terminals such as personal computers, portable telephones, and portal information terminals. Elastic waves are used for transmission/reception of information at the communication nodes 100-1 to 100-8.

In this case, in each of the communication lines 101-1 to 101-15, an elastic member is used as a transmission medium. If air is selected as an elastic member serving as a transmission medium, transmission/reception using sonic waves (ultrasonic waves) as transmission means is realized. If en elastic member serving as a transmission medium is a solid member, an object existing in daily life, e.g., a desk, wall, or table, can be used as a transmission medium. An elastic member serving as a transmission medium may be a liquid.

Some of the communication nodes 100-1 to 100-8 may be connected to each other through a wire line. Communication among the communication nodes 100-1 to 100-8 may be done through the wire line. Communication among the communication nodes 100-1 to 100-8 may be relayed by other communication nodes. When, for example, communication is to be performed from the communication node 100-5 to the communication node 100-1, the communication may be relayed by the communication line 101-13, communication node 100-6, communication line 101-10, communication node 100-8, and communication line 101-4. A given communication node may be simultaneously connected to a plurality of communication nodes other than the above communication nodes. For communication lines which are geographically distant from each other, elastic waves in the same frequency band are repeatedly used. For example, elastic waves in the same frequency band are repeatedly used for the communication lines 101-12 and 101-15 in FIG. 1.

FIG. 2 shows an example of the ultrasonic wave generator for generating the above elastic waves. The ultrasonic wave generator shown in FIG. 2 has eight ultrasonic elements D01 mounted at equal intervals on the outer surface of a shaft D02. With an increase in frequency, an elastic wave loses its diffraction effect, and hence exhibits higher rectilinearity. According to an arrangement having a plurality of ultrasonic elements in the form of an array like that shown in FIG. 2, elastic waves can be emitted in all directions.

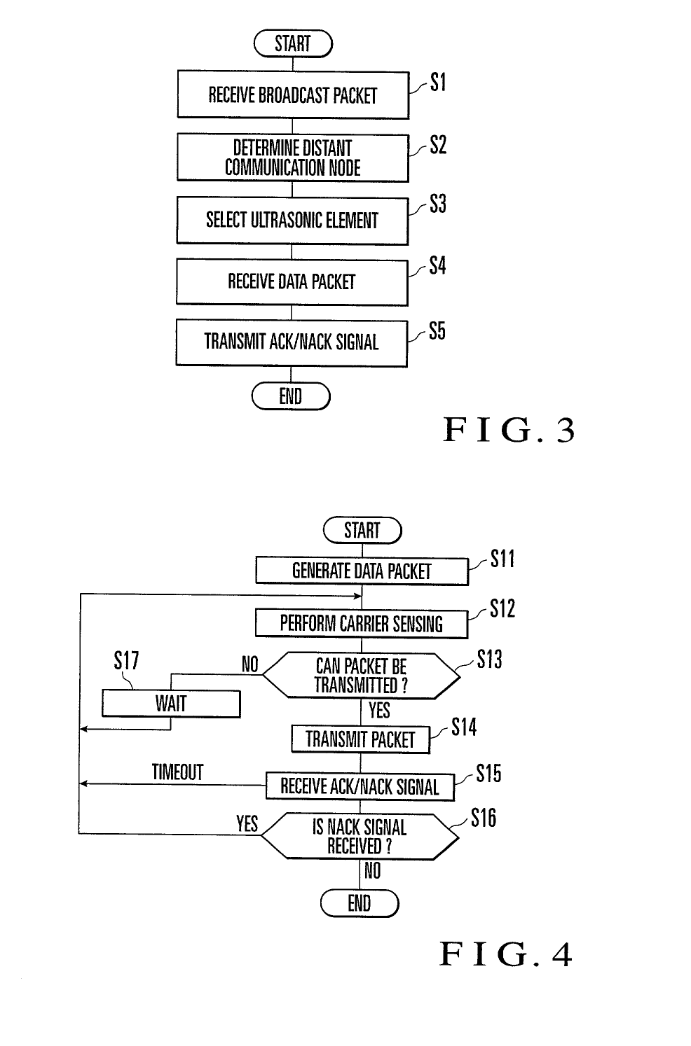

FIG. 3 shows an example of the reception processing executed at a communication node 100 (100-1 to 100-8). Referring to FIG. 3, in step S1, the communication node 100 receives a broadcast packet from another communication node as a distant node. If a plurality of ultrasonic elements are provided for the communication node 100, the signals received by the respective elements are diversity-received. The broadcast packet is broadcast by using a predetermined frequency, and contains the ID number of the communication node as the transmission source, frequency information used for transmission/reception of a data packet, and the like. The broadcast packet is received by a plurality of ultrasonic elements arrayed on the communication node 100. A broadcast packet is periodically transmitted from each communication node to the communication node 100.

The communication node 100 receives broadcast packets from a plurality of other communication nodes. In step S2, the communication node 100 determines one of the plurality of received broadcast packets as the one from the distant node, and knows the node ID of the distant node by referring to the communication node ID contained in the determined broadcast packet. In this case, a communication node that has transmitted a broadcast packet with the strongest reception power is determined as a distant node.

In step S3, the communication node 100 selects a transmission ultrasonic element used for transmission of a data packet on the basis of the received broadcast packet. A transmission ultrasonic element is selected by the following methods. In the first method, an element exhibiting the highest reception power is selected. In the second method, transmission is performed from all the ultrasonic elements while the weight applied to the output level of each element is changed. In the third method, transmission is performed from all the ultrasonic elements while the output phase and amplitude of each element are changed at the time of transmission.

In step S4, a data packet transmitted from the distant node is received. In this case, if the packet is properly received, an ACK signal is transmitted to the distant node in step S5. If the packet is not properly received, an NACK signal is transmitted to the distant node in step S5. The above broadcast packet may include a data packet.

FIG. 4 shows an example of the transmission processing executed at the communication node 100 so as to explain how this processing is associated with the reception processing shown in FIG. 3. This example of the transmission processing is based on a premise that transmission and reception are performed by using the same frequency. The frequency to be used may be informed in advance by a broadcast packet or an appropriate frequency may be selected between two communication nodes after a broadcast packet is received and a pair of communication lines are ensured.

When a data packet is generated at the communication node 100 in step S11, carrier sensing is performed in step S12. If no interference carrier is detected in step S13, it is determined that communication can be performed, and a data packet is transmitted in step S14. If an interference carrier is detected in step S13, it is determined that interference exists. After a certain standby time in step S17, the flow returns to step S12. In step S17, the standby time may be a fixed time interval or random time interval.

After the data packet is transmitted in step S14, the flow waits until an ACK/NACK signal is received from the distant node in response to the data packet in step S15. If the signal is received, the flow advances to step S16. If no signal is received after an elapse of a predetermined period of time, the flow returns to step S12 to retransmit the data packet. In step S16, the communication node 100 checks whether the received signal is an NACK signal. If YES in step S16, the flow returns to step S12 to retransmit the data packet.

As described above, in the personal area network, since the distance between communication devices is short, communication can be performed by using elastic waves and air or one of various kinds of solid members as a transmission medium.

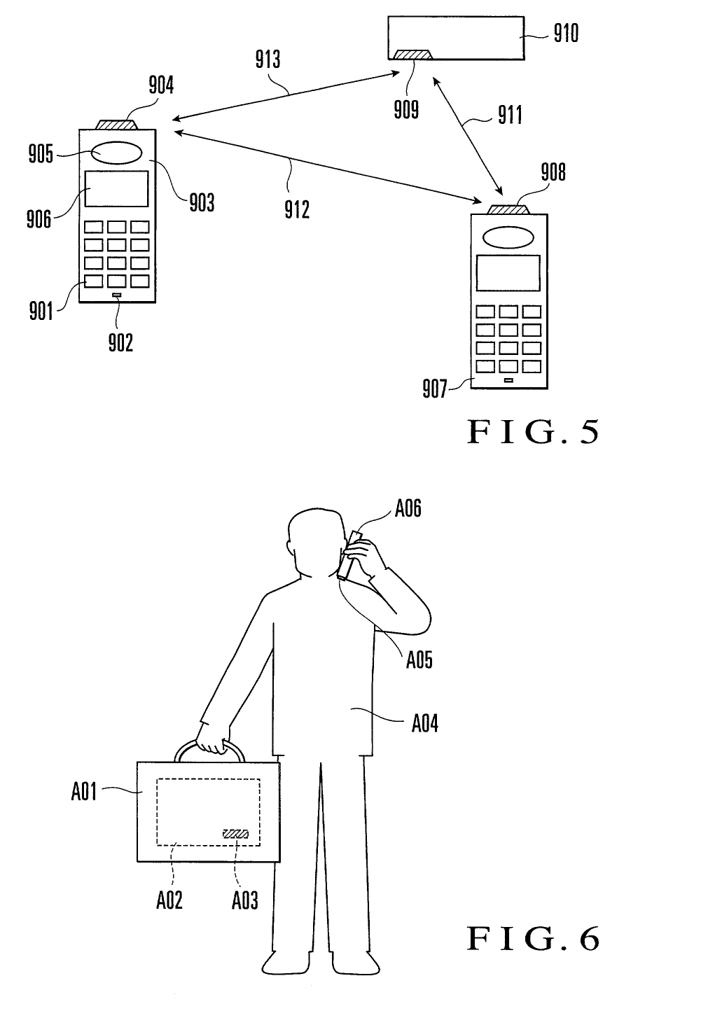

FIG. 5 shows an example of the communication system using air as a transmission medium. Referring to FIG. 5, portable information terminals 903 and 907 communicate with a base station 910 by using ultrasonic elements 904 and 908, mounted on the self-terminals, through aerial transmission paths 913 and 911. At this time, the base station 910 communicates with the portable information terminals 903 and 907 by using an ultrasonic element 909. The portable information terminals 903 and 907 directly communicate with each other through an aerial transmission path 912. Reference numeral 905 denotes an earphone, 906, a display section; and 902, a microphone.

FIG. 6 shows another example of the communication system using air as a transmission medium. Referring to FIG. 6, when an operator A04 performs communication by using an information terminal A06, elastic waves are emitted from an ultrasonic element A05 of the information terminal A06 into the air. The elastic waves emitted from the ultrasonic element A05 are received by an ultrasonic element A03 mounted in a personal computer A02 in a bag A01 carried by the operator A04 through air as a transmission medium. If radio wave communication unit is incorporated in the personal computer A02, the personal computer A02 transmits the signal received from the information terminal A06 to another radio wave receiver through a radio communication unit. According to this example, radio communication between the information terminal and the personal computer can be realized without using and electromagnetic waves.

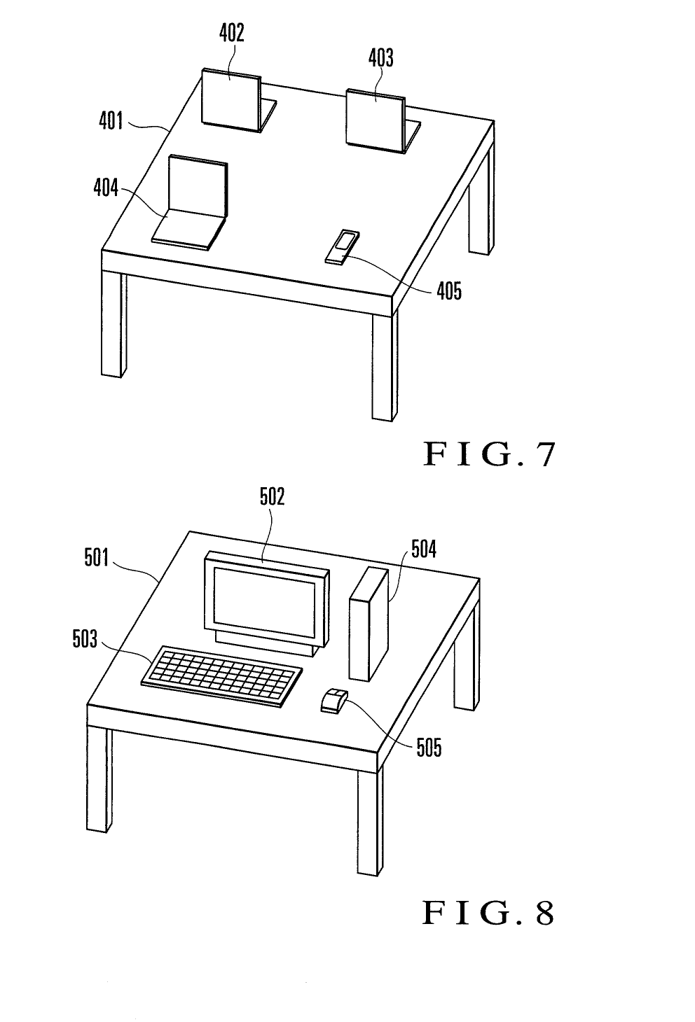

FIG. 7 shows an example of the communication system using a solid member as a transmission medium. Referring to FIG. 7, notebook personal computers 402, 403, and 404 and portable information terminal 405 serving as communication nodes are placed on a desk 401. The notebook personal computers 402, 403, and 404 and portable information terminal 405 communicate with each other by using elastic waves through the desk 401 as a transmission medium. When the desk 401 is used as a transmission medium, the respective communication nodes are placed on the desk such that the transmission/reception elements for generating and receiving elastic waves are brought into contact with the desk.

According to this example, an ad hoc network can be formed by only placing communication nodes on the desk 401 without using any dedicated cable. Since no electromagnetic wave is used, no interference occurs with other radio communication devices using electromagnetic waves. In addition, since the desk 401 is used as a transmission medium, no interference occurs with other communication devices using elastic waves, which perform communication by using air as a transmission medium.

FIG. 8 shows still another example of the communication system using a solid member as a transmission medium. Referring to FIG. 8, a keyboard 503, display 502, personal computer body 504, and mouse 505 as communication nodes are placed on a desk 501. The keyboard 503, mouse 505, and personal computer body 504 exchange operation key information of the keyboard 503 and movement information of the mouse 505 through the desk 501 serving as a transmission medium. The personal computer body 504 and display 502 exchange screen display information through the desk 501 as a transmission medium. When the desk 501 is used as a transmission medium, the transmission/reception elements of the respective communication nodes which are used to generate and receive elastic waves are placed on the desk 501 to come into contact therewith.

According to this example, since no cable is required, the space on the desk can be used more effectively.

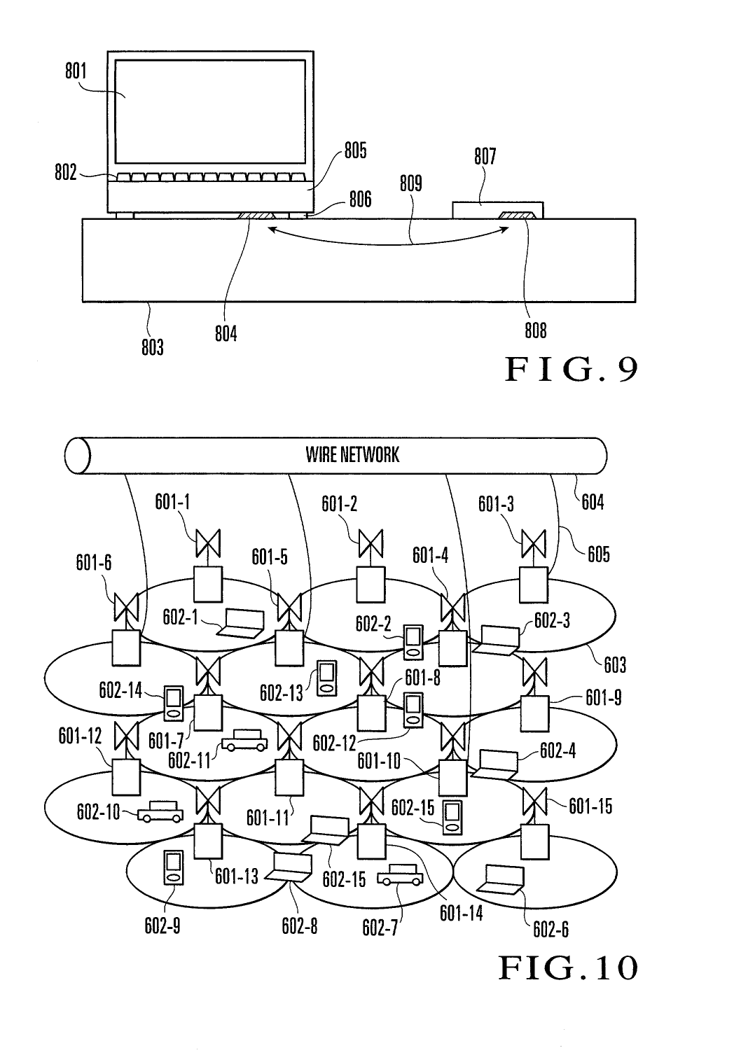

FIG. 9 schematically shows a case where a personal computer and portable information terminal are placed on a table 803. Referring to FIG. 9, ultrasonic elements 804 and 808 are so mounted as to come into contact with the surface of the table 803 when a personal computer body 805 and portable information terminal 807 are placed on the table 803. The elastic waves emitted from the ultrasonic elements 804 and 808 propagate along a propagation route 809 through the table 803 serving as a solid transmission medium, thereby transmitting/receiving signals to/from other ultrasonic elements. Note that an ultrasonic element may be incorporated in a stabilizer 806. Reference numeral 802 denotes a keyboard; and 801, a display.

FIG. 10 shows a case where the present invention is applied to a cellular mobile communication system. Communication nodes are classified into base stations 601 and terminals 602. The terminal 602 can move. Terminals 602-1 to 602-15 are respectively connected to nearby base stations 601-1 to 601-15, can communicate with each other by using elastic waves. Each base station 601 takes charge of its own area (cell). For example, FIG. 10 shows a cell 603 for the base station 601-3. When a given terminal 602 has moved from a given cell to another cell, the terminal 602 performs connection switching (handover) to the base station 601 belonging to the latter cell. For cells that are geographically distant from each other, elastic waves having the same frequency are repeatedly used.

All or some of the base stations 601-1 to 601-15 are connected to a wire network 604 through wire lines 605. The signal output from each of the terminals 602-1 to 602-15 is transmitted to the wire network through a corresponding one of the base stations 601-1 to 601-15. This realizes transmission/reception of signals to/from various communication targets. As the write network, the Internet or the like is available. Examples of the communication targets are home personal computers and various telephones (stationary and portable telephones).

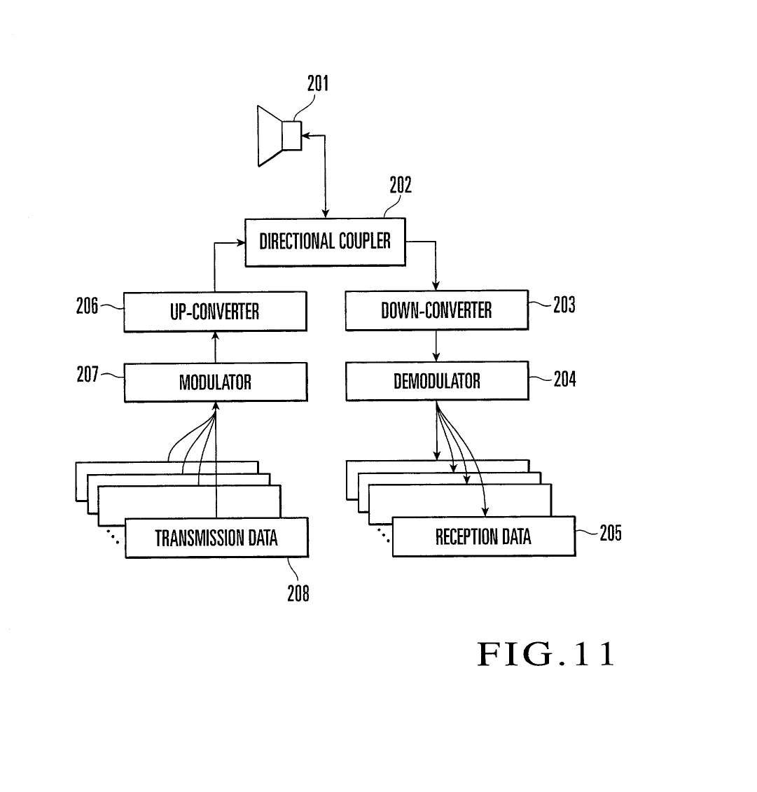

FIG. 11 is a block diagram of a transmission/reception circuit provided for a communication node. Referring to FIG. 11, the elastic wave signals output from one or more communication nodes are input to a transmission/reception element 201 and converted into electrical signals. The transmission/reception element 201 is an element for efficiently converting elastic waves into electrical signals or vice versa. For example, a speaker or piezoelectric element is used as this element. Each reception signal converted into an electrical signal is converted into a baseband signal by a down-converter 203 through a directional coupler 202. The reception signal converted into the baseband signal is demodulated by a demodulator 204 to obtain reception data 205. The demodulator 204 extracts a desired signal from a multiplexed reception signal. The demodulator 204 decodes the desired signal if it is encoded.

As a multiplexing method, a time division multiplexing method, frequency division multiplexing method, code division multiplexing method, or a combination thereof is used. The demodulator 204 may equalize the reception signal if it is distorted on the transmission path. The reception data 205 is reception data transmitted from one or a plurality of transmission nodes.

Transmitting operation at a given communication node will be described next. One or more transmission data 208 are input to a modulator 207 to generate a modulated signal. If there are a plurality of transmission data 208, the modulator 207 multiplexes them. As a multiplexing method, a time division multiplexing method, frequency division multiplexing method, code division multiplexing method, or a combination thereof is used. The modulator 207 may perform encoding to reduce transmission errors. The output signal from the modulator 207 is input to an up-converter 206 to be converted into a signal in a higher frequency band. The output from the up-converter 206 is converted into an elastic wave by the transmission/reception element 201 through the directional coupler 202. This elastic wave is then transmitted to another communication node.

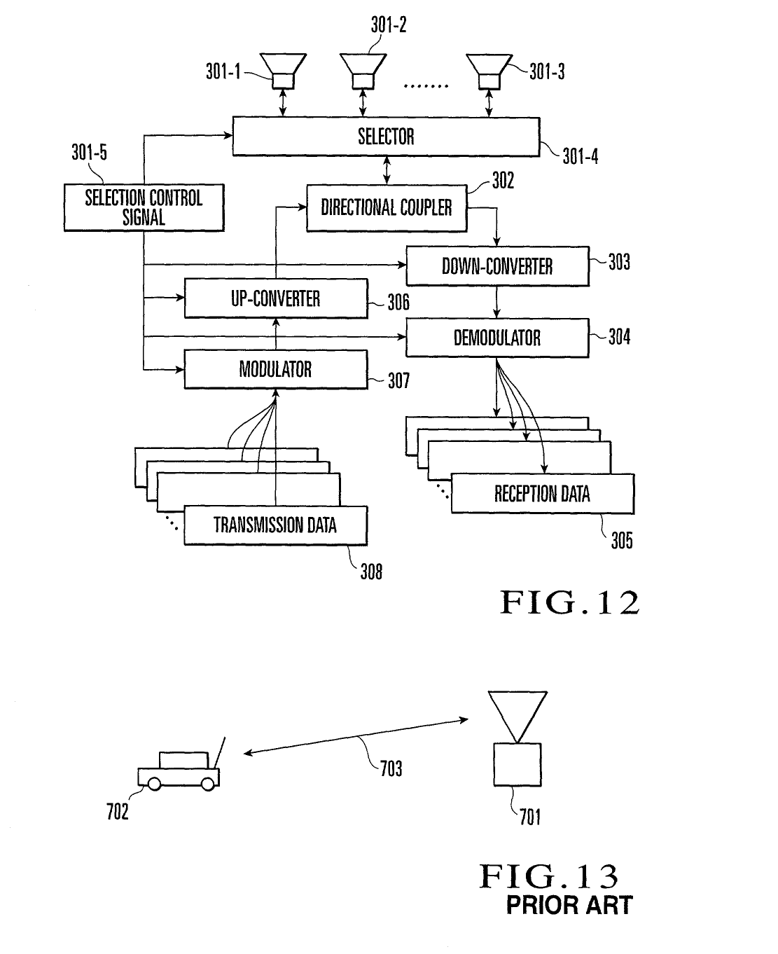

If a transmission medium is a solid member (e.g., a desk or wall) or a liquid (e.g., water), communication can be performed at a higher transmission rate than when the transmission medium is a gas (e.g., air). A communication node arrangement which adaptively selects/changes communication parameters such as a transmission/reception element, transmission rate, and carrier frequency in accordance with each transmission medium will be described with reference to FIG. 12.

Referring to FIG. 12, a plurality of transmission/reception elements 301-1 to 301-3 are connected to a selector 301-4. The transmission/reception elements 301-1 to 301-3 are elements for efficiently converting elastic waves into electrical signals or vice versa. As these elements, speakers or piezoelectric elements are used. Each transmission/reception element is comprised of a plurality of ultrasonic elements arranged in the form of an array. A directional coupler 302 is connected to the selector 301-4. A selection control signal 301-5 is input to the selector 301-4. An operator selects one of the transmission/reception elements 301-1 to 301-3. The selection control signal 301-5 is a control signal for selecting one of the transmission/reception elements 301-1 to 301-3. The elastic wave signals output from one or more communication nodes are input to one of the transmission/reception elements 301-1 to 301-3 which is selected by the selector 301-4 and converted into an electrical signal. The reception signal converted into the electrical signal is converted into a baseband signal by a down-converter 303 through the directional coupler 302. The reception signal converted into the baseband signal is demodulated by a demodulator 304 to obtain reception data 305.

Selection control signals are input from the selection control signal 301-5 to the down-converter 303 and demodulator 304, respectively, to adjust communication parameters such as a modulation frequency and transmission rate. The demodulator 304 extracts a desired signal from the multiplexed reception signal. The demodulator 304 also decodes the desired signal if it is encoded. As a multiplexing method, a time division multiplexing method, frequency division multiplexing method, code division multiplexing method, or a combination thereof is used. The demodulator 304 may equalize the reception signal if it is distorted on the transmission path. The reception data 305 is reception data transmitted from one or a plurality of transmission nodes.

Transmitting operation in FIG. 12 will be described next. One or more transmission data 308 are input to a modulator 307 to generate a modulated signal. If there are a plurality of transmission data 308, the modulator 307 multiplexes them. As a multiplexing method, a time division multiplexing method, frequency division multiplexing method, code division multiplexing method, or a combination thereof is used. The modulator 307 may perform encoding to reduce transmission errors. The output signal from the modulator 307 is input to an up-converter 306 to be converted into a signal in a higher frequency band. The output from the up-converter 306 is converted into an elastic wave by one of the transmission/reception elements 301-1 to 301-3 through the directional coupler 302 and selector 301-4. This elastic wave is then transmitted to another communication node. Selection control signals are input from the selection control signal 301-5 to the modulator 307 and up-converter 306, respectively, to adjust communication parameters such as a modulation frequency and transmission rate.

As has been described above, according to the present invention, since communication is performed by using elastic waves, there is no need to allocate a new electromagnetic wave frequency for short-range communication, and electromagnetic waves can be effectively used. In addition, since elastic waves are used, the influence on the human body is smaller than that when electromagnetic waves are used. As a transmission medium for elastic waves, any object existing in daily life, e.g., a solid member, liquid, gas, can be used, and hence no dedicated transmission unit is required. For example, the use of a desk as a transmission medium is optimal for the construction of a personal network. If a dedicated transmission unit, more efficient transmission can be realized. If elastic waves based on air as a medium, e.g., sonic waves (ultrasonic waves), are used, since a transmission attenuation occurs steeply with an increase in distance, interference with other communication devices can be further suppressed. In a system designed to repeatedly use the same frequency, like a cellular system, in particular, a high frequency use efficiency can be attained.

What is claimed is:

1. A communication system for performing short-range radio communication between a plurality of communication nodes, wherein
each of said communication nodes comprises:
a transmission/reception unit which transmits/receives an elastic wave;
a first circuit which drives said transmission/reception unit on the basis of transmission data; and
a second circuit which demodulates reception data from an output from said transmission/reception unit.

2. A system according to claim 1, wherein a transmission medium for the elastic wave is a solid member.

3. A system according to claim 2, wherein the solid member is a desk.

4. A system according to claim 3, wherein said communication node is placed on the desk such that said transmission/reception unit is brought into contact with the desk.

5. A system according to claim 1, wherein a transmission medium for the elastic wave is a gas.

6. A system according to claim 5, wherein the gas is air, and the elastic wave is a sonic wave.

7. A system according to claim 6, wherein said transmission/reception unit comprises an ultrasonic unit having a plurality of ultrasonic elements in the form of an array which emit the elastic waves in all directions.

8. A system according to claim 1, wherein when said communication nodes are geographically distant from each other, an elastic wave having the same frequency is repeatedly used.

9. A system according to claim 1, wherein
said communication node comprises:
a plurality of base stations arranged in a plurality of cells obtained by dividing a service area; and
a mobile terminal which is located in a cell and communicates with a corresponding one of said base stations, and
communication between said base station and said mobile terminal in two cells which are distant from each other is performed by repeatedly using the elastic wave of the same frequency.

10. A system according to claim 1, wherein
said communication node is connected to a wire network, and
communication using the elastic wave and communication through said wire network are selectively performed between said communication nodes.

11. A method of performing short-range radio communication between a base station and a mobile terminal, comprising the steps of:
multiplexing transmission signals at the base station;
converting the multiplexed signal into an elastic wave and transmitting the elastic wave from the base station to the terminal;
multiplexing transmission signals at the terminal connected to the based station, and
converting the multiplexed signal into an elastic wave and transmitting the elastic wave from the terminal to the base station.

12. A method according to claim 11, wherein a transmission medium for the elastic wave is air, and the elastic wave is a ultrasonic wave.
